(19) United States
(12) Patent Application Publication
(10) Pub. No.: US 2019/0080063 A1
(43) Pub. Date: Mar. 14, 2019

(54) DE-IDENTIFICATION ARCHITECTURE

(71) Applicant: Facebook, Inc., Menlo Park, CA (US)

(72) Inventors: Derrick Francis Rice, Somerville, MA (US); Scott Renfro, Los Altos, CA (US)

(21) Appl. No.: 15/703,916

(22) Filed: Sep. 13, 2017

(51) Int. Cl. G06F 21/31; G06N 5/00; G06F 17/30

(52) U.S. Cl. CPC G06F 21/316; G06N 5/003; G06F 2221/2141; G06F 2221/2143; G06F 17/30109

(57) ABSTRACT

The present disclosure relates to techniques for processing personally identifiable information (PII). The techniques may include accessing a log data storage that stores log data, wherein the log data is structured into multiple dimensions; isolating a partition of the log data in the log data storage, wherein the partition is associated with one dimension of the multiple dimensions and is associated with a first characterization of presence or absence of PII in the partition; processing, using a machine-learning (ML) based classifier and based on a model, the partition to generate a second characterization of presence or absence of PII in the partition; comparing the first characterization against the second characterization; and based on a result of the comparison, performing one or more actions.

### BACKGROUND

Online systems, such as social networking systems or other content-sharing systems, enable a user to communicate with other users. The communication can be in the form of, for example, messaging, posting of content, etc. Moreover, a user may also provide certain user-identifiable information (e.g., legal name, address, phone number, etc.) to receive certain services from the online systems. The online systems may maintain records of the communications, as well as records of the user-identifiable information. The user may access the records to perform other transactions in the online systems. The records may also be provided to other parties for other purposes (e.g., to perform data analytics, to complete a transaction, etc.).

All these records may include personally identifiable information (PII), which can be used on its own or with other information to identify, contact, or locate a single person, or to identify the person in context. For example a legal name can be used to identify the holder of the legal name, whereas the address and phone number information provide the contact information of a person. Moreover, some of the content of the communication may reveal a person's relationship with another person, or a sequence of events (e.g., place visits, life events, etc.) that can be used to identify the person. These records can pose privacy risks if not they are not handled properly.

For privacy protection, current online systems may perform certain processing on the records, to reduce the likelihood of exposing the PII of the users of the online systems. Some online systems may perform the processing based on a pre-determined privacy protection policy. For example, within a certain period of time after the record is created, or based on a user's request, the record may be examined to identify information in the record that can potentially be used as PII. The identified information can then be processed (e.g., by partial obfuscation, replacement with less sensitive information, etc.) based on the pre-determined privacy protection policy, such that it becomes exceedingly difficult, if not impossible, to derive PII from the processed information. The examination of the record can be performed by trusted human reviewers, by a software application that parses the record based on predetermined heuristics, or by a combination of both.

Due to the increasing popularity of online systems, the online systems may maintain significant amount of user-identifiable information as well as communication records containing PII. It becomes difficult to completely identify PII from the records. This may lead to the failure to process information that can potentially be PII, which can pose privacy risks to the users.

### SUMMARY

The present disclosure relates to techniques for processing personally identifiable information (PII). More specifically, in certain aspects of the present disclosure, a computer-implemented method is provided. The method may include accessing a log data storage that stores log data, wherein the log data is structured into multiple dimensions; isolating a partition of the log data in the log data storage, wherein the partition is associated with one dimension of the multiple dimensions and is associated with a first characterization of presence or absence of PII in the partition; processing, using a machine-learning (ML) based classifier and based on a model, the partition to generate a second characterization of presence or absence of PII in the partition; comparing the first characterization against the second characterization; and based on a result of the comparison, performing one or more actions.

In some embodiments, the log data is structured into two dimensions comprising a set of rows and a set of columns, wherein the partition is isolated from a column of the set of columns. The set of rows can be associated with a set of timestamps.

In some embodiments, the model may comprise a decision tree constructed based on partitioning a set of training log data into subsets and performing entropy calculations on the subsets. The second characterization may be generated based on one or more decisions from the decision tree.

In some embodiments, the model may comprise a bloom filter constructed based on a first set of hash values generated from a set of training log data labelled as PII using a set of hash functions. The processing of the partition to generate the second characterization of presence or absence of PII in the partition may comprise generating a second set of hash values from the partition using the set of hash functions, and determining the second characterization based on whether the second set of hash values is included in the first set of hash values.

In some embodiments, the one or more actions may comprise updating a set of rules associated with the generation of the first characterization, wherein the set of rules includes a set of pre-determined data patterns associated with PII. The pre-determined data patterns may comprise at least one of: a predetermined numeric schema, a pre-determined group of American Standard Code for Information Interchange (ASCII) codes, or a pre-determined data type associated with PII.

In some embodiments, the one or more actions may also comprise identifying one or more PII from the partition based on the updated set of rules, and de-identifying the one or more PII. In some embodiments, the de-identifying of the one or more PII may comprise obfuscating the one or more PII in the partition. In some embodiments, the de-identifying of the one or more PII may also comprise determining that a first identifier included in the partition to be PII, determining, based on the first identifier, a second identifier that is determined to be non-PII; and replacing the first identifier with the second identifier in the partition.

In some embodiments, the one or more actions may comprise transmitting a notification to a generator of the first characterization; monitoring for a response from the generator after transmitting the notification; and based on a determination that the response has not been received before a pre-determined time, making at least the partition inaccessible to the generator. In some embodiments, the generator may be a human administrator.

In some embodiments, the method may further comprise receiving a triggering event. The partition may be processed to generate the second characterization based on the reception of the triggering event. The triggering event may comprise an expiration event of a timer. The timer can be started when the partition is first created in the log data storage.

In some embodiments, the partition can be a first partition. The method may further comprise: isolating a second partition of the log data in the log data storage; and processing, using the ML based classifier and based on the model, the second partition to generate a third characterization of presence or absence of PII in the second partition.

According to certain embodiments of the present disclosure, a system is provided. The system may one or more processors; and a non-transitory computer-readable medium storing instructions that, when executed by the one or more processors, cause the one or more processors to perform operations including: accessing a log data storage that stores log data, wherein the log data is structured into multiple dimensions; isolating a partition of the log data in the log data storage, wherein the partition is associated with one dimension of the multiple dimensions and is associated with a first characterization of presence or absence of personally identifiable information (PII) in the partition; processing, using a machine-learning (ML) based classifier and based on a model, the partition to generate a second characterization of presence or absence of PII in the partition; comparing the first characterization against the second characterization; and based on a result of the comparison, performing one or more actions.

In some embodiments, the log data can be structured into two dimensions comprising a set of rows and a set of columns. The partition can be isolated from a column of the set of columns. The set of rows can be associated with a set of timestamps.

In some embodiments, the model may comprise at least one of: a decision tree constructed based on partitioning a set of training log data into subsets and performing entropy calculations on the subsets, or a bloom filter constructed based on a first set of hash values generated from a set of training log data labelled as PII using a set of hash functions.

In some embodiments, the one or more actions may comprise at least one of: de-identifying one or more PII in the partition; or transmitting a notification to a generator of the first characterization.

In certain embodiments of the present disclosure, a non-transitory computer-readable storage medium is provided. The non-transitory computer-readable storage medium may store a plurality of instructions executable by one or more processors, the plurality of instructions, when executed by the one or more processors, cause the one or more processors to: access a log data storage that stores log data, wherein the log data is structured into multiple dimensions; isolate a partition of the log data in the log data storage, wherein the partition is associated with one dimension of the multiple dimensions and is associated with a first characterization of presence or absence of personally identifiable information (PII) in the partition; process, using a machine-learning (ML) based classifier and based on a model, the partition to generate a second characterization of presence or absence of PII in the partition; compare the first characterization against the second characterization; and based on a result of the comparison, perform one or more actions.

### BRIEF DESCRIPTION OF THE DRAWINGS

Illustrative embodiments are described in detail below with reference to the following figures:

FIG. 1 is a simplified block diagram of a social networking system;

FIG. 2 is a simplified block diagram illustrating an example of a source of events according to aspects of the present disclosure;

FIG. 3 is a simplified block diagram illustrating a data structure for storing one type of log data according to aspects of the present disclosure;

FIG. 4 is a simplified block diagram illustrating a data structure for storing another type of log data to be processed by example systems and methods according to certain aspects of the present disclosure;

FIG. 5 is a simplified block diagram illustrating an example of a result of processing on the data of FIG. 4 according to certain aspects of the present disclosure;

FIG. 6 is a simplified flowchart illustrating an example of a method of processing personally identifiable information (PII), according to certain aspects of the present disclosure;

FIG. 7 is a simplified block diagram illustrating an example of a social network host for implementing some of the examples disclosed herein;

FIGS. 8 and 9 are simplified block diagrams illustrating examples of prediction models for implementing some of the examples disclosed herein;

FIG. 10 is a simplified flowchart illustrating an example of a method of processing PII, according to certain aspects of the present disclosure; and

FIG. 11 is an example of a block diagram of a computing system for implementing some of the examples disclosed herein.

### DETAILED DESCRIPTION

### I. Social Networking System

A social networking system is a highly interactive online platform through which individuals, communities, and organizations can create, share, discuss, and modify user-generated content or pre-made content posted online. The user-generated content may include, for example, text posts or comments, digital photos or videos, and data generated through all online interactions. Virtual communities and online networks may be created in the social networking system when a user connects his or her profile with those of other individual users or groups. Connected users may share information with each other, within a group, within a community, or within the whole network, which may include billions of users. Social networking systems are generally enabled by web-based technologies, mobile technologies, and computer technologies, including the Internet, mobile devices, computer servers and data centers, wireless wide-area networks (WWANs), wireless local area networks (WLANs), wireless personal area networks (WPANs), etc.

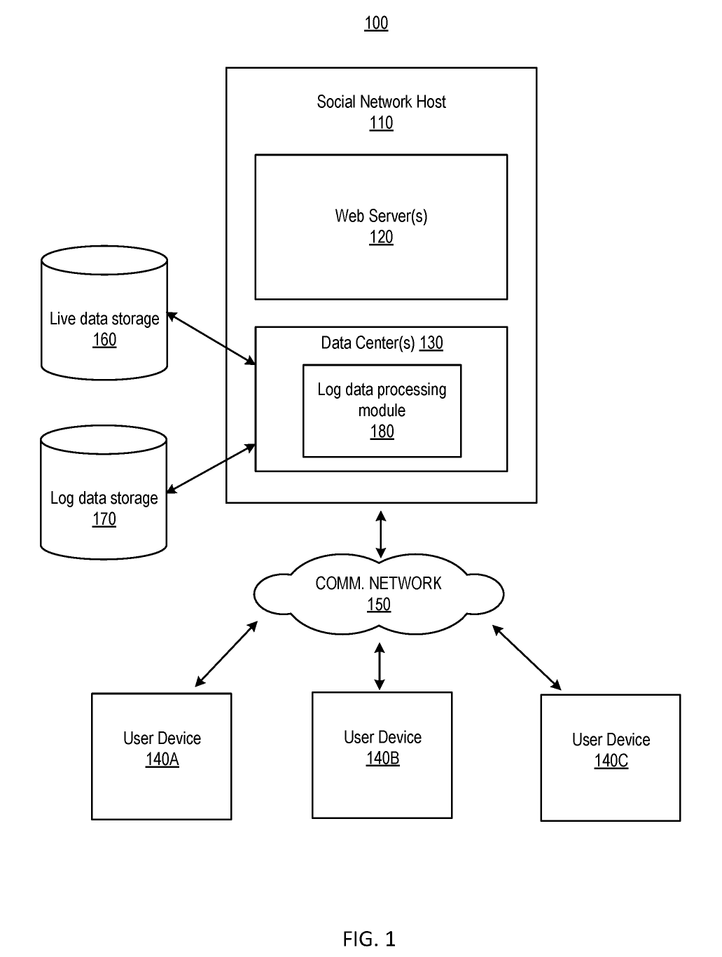

FIG. 1 is a simplified block diagram of a social networking system 100. Social networking system 100 may include a social network host 110 connected to one or more user devices 140A, 140B, and 140C (collectively “140”), through a communication network 150, which may include communication links using technologies such as Ethernet, IEEE 802.11, worldwide interoperability for microwave access (WiMAX), 3G, 4G, 5G, code division multiple access (CDMA), digital subscriber line (DSL), etc.

Social network host 110 may include one or more web servers 120 and one or more data centers 130. Web server(s) 120 may serve web pages, as well as other content, such as JAVA®, FLASH®, XML, and so forth. A user may send a request to web server(s) 120 to upload information (e.g., images or videos) that may be stored in data center(s) 130. Web server(s) 120 may also receive and route messages, such as instant messages, queued messages (e.g., email), text messages, short message service (SMS) messages, or messages sent using any other suitable messaging technique, between social network host 110 and user devices 140.

Data center(s) 130 may include one or more use profile stores, where a user profile for each user of social networking system 100 may be stored. A user profile may include multiple data fields, each of which may describe one or more attributes of the corresponding user. Data center(s) 130 may also include one or more edge stores that store information regarding connections between users and other objects on the social networking system 100 as edges. Some edges may be defined by users, thus allowing users to specify their relationships with other users. Users may generate edges with other users that parallel the users' real-life relationships, such as family, friends, coworkers, partners, and so forth. For example, a first user may indicate that a second user is a “friend” of the first user or request to add the second user as a friend. In response to this indication or request, social networking system 100 (more specifically, social network host 110) may transmit a “friend request” to the second user. If the second user confirms the “friend request,” social networking system 100 may associate the two users through an edge. The edge may represent, for example, a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

Data center(s) 130 may further include one or more content stores that store objects each representing various types of content. Examples of content represented by an object may include, for example, a page post, a status update, a photograph, a video, a link, a shared content item, a gaming application achievement, a check-in event at a local business, a brand page, or any other type of content. Data center(s) 130 may also include one or more action stores that may be used by social network host 110 to track user actions on social networking system 100. Users may interact with various objects on social networking system 100, and information describing these interactions may be stored in the action stores. Examples of interactions with objects may include, for example, commenting on posts, sharing links, checking-in at physical locations, accessing content items, etc.

Each of the one or more user devices 140 may correspond to a user and may comprise a processor, memory (with volatile memory and/or non-volatile storage drives), input and output interfaces, or other hardware or software known in the art. User device(s) 140 may be used to provide input content to social network host 110 through a network page of social networking system 100 or a user application software (“app”). The input content may be generated by a first user using a first user device (e.g., via a keyboard, camera, etc.), or may be created by a third party and posted by the first user using the first user device (e.g., by downloading, copying, pasting, or sharing a link, etc.) to social networking system 100. The input content posted by the first user may be provided to a newsfeed linked to the profile of the first user and provided to other users that are connected with the first user. The other users may then access the content, post comments, or share the link. Each of these other users may have a corresponding unique profile within social networking system 100.

Social networking system 100 may include a live data storage 160 to provide the aforementioned profile store, edge store, content store, as well as action store for a particular user to data center(s) 130. Live data storage 160 can store the latest profile of a user, and continuously accumulate events of the user associated with, for example, creation (or severing) of edges between the user and other users or objects, posting of content by the user, various actions performed by the user with various objects on social networking system 100, etc. The events can be detected by web server(s) 120 on a web site hosted by the server(s).

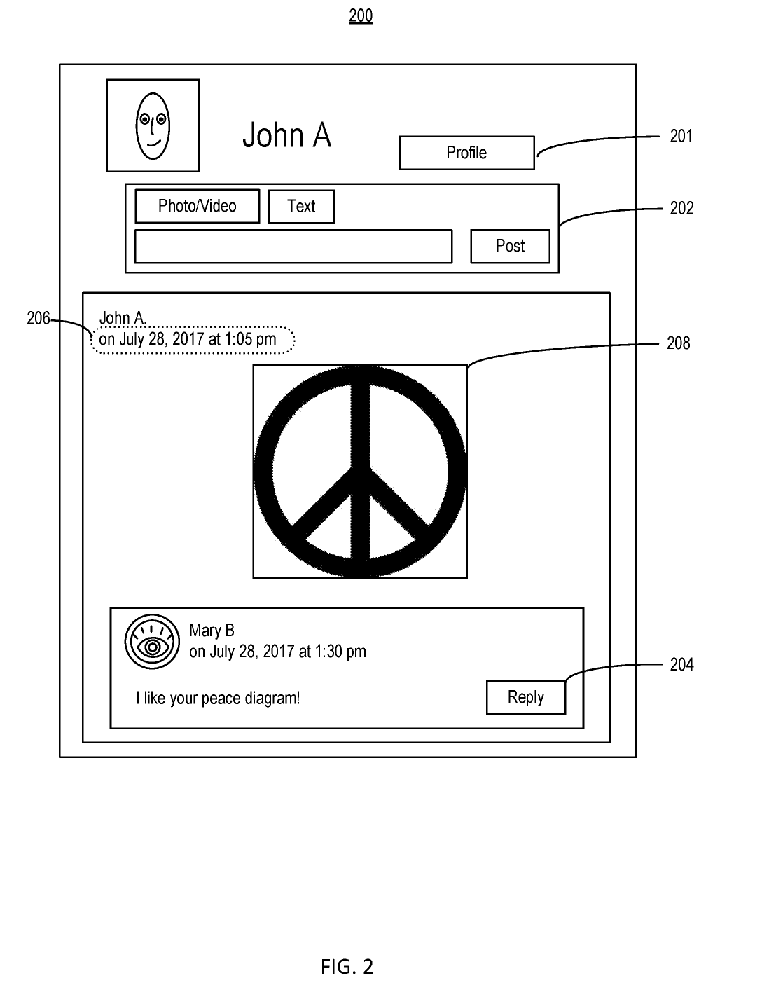

Reference is now made to FIG. 2, which illustrates an example of a source of events according to aspects of the present disclosure. A source of log data can be, for example, interaction between web site 200 hosted by web server(s) 120 and the users. Web site 200 is associated with a user (in the example of FIG. 2, “John A”), and includes a number of input interfaces, which can generate data stored in live data storage 160. For example, web site 200 includes an input interface 201 that allows the user to input or edit his profile, which can include a set of user-identifiable information associated with the user. Web server(s) 120 can detect the creation or editing of the user's profile, and provide the user profile data to data center(s) 130, which can then store the user profile data in live data storage 160. Moreover, web site 200 also includes an input interface 202 for the user to post certain content (e.g., a text message, a photo, a video, etc.), and an input interface 204 for the user to post a reply to content posted by another user. Web server(s) 120 can detect the posting of the content by the user, based on indications from input interfaces 202 and 204, and determine a timestamp associated with the posting. Web server(s) 120 can also assign an identifier (e.g., a post identifier) to the content posted by the user. Web server(s) 120 can display some of this event information on web site 200 (e.g., time stamp 206, post content 208, etc.), and provide the event information to data center(s) 130. Data center(s) 130 can associate the event data with the user John A, and store the event data, as well as the association with John A, in live data storage 160. Web server(s) 120 can also detect a user's activity on another web site not associated with that user. For example, as shown in FIG. 2, another user (“Mary B”) posted a comment on web site 200. Web server(s) 120 can detect the posting event by Mary B, and provide the event information (e.g., timestamp, post identifier, etc.) to data center(s) 130. Data center(s) 130 can also associate the event data with the user Mary B, and store the event data, as well as the association of the event data with Mary B, in live data storage 160.

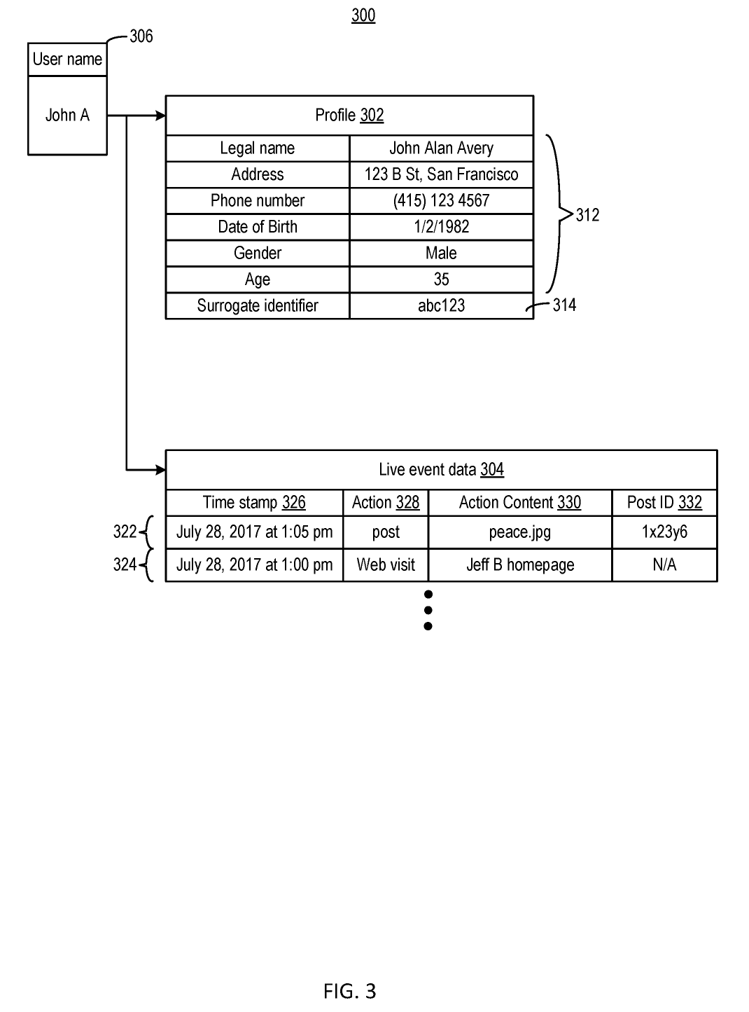

Reference is now made to FIG. 3, which illustrates an example of a data structure 300 stored in live data storage 160, according to aspects of the present disclosure. As shown in FIG. 3, data structure 300 includes a profile 302 and live event data 304, both of which are associated with a user name 306 (“John A”). Profile 302 can include the information provided or assigned to the user when, for example, the user activates interface 201 on web site 200. Profile 302 may include personal information 312 provided by the user, such as the user's legal name, address, phone number, date of birth, gender, age, etc. Profile 302 may also include other information, such as system-assigned identifiers. For example, profile 302 may include a surrogate identifier 314 mapped to user name 306. As to be discussed in more details below, in some other data storage, surrogate identifier 314 can be used (in lieu of user name 306) to represent a user in log data. The replacement of user name with a surrogate identifier can be part of a de-identification process to reduce the likelihood of exposing PII of the user. For example, profile 302 may be the only place that stores the association between surrogate identifier 314 and user name 306. In the event that the user decides to discontinue using social networking system 100, the user profile 302, as well as the mapping between user name 360 and surrogate identifier 314, can be removed from data storage 160. With the mapping removed, it may become difficult (if not impossible) to determine the identity of the user based on surrogate identifier 314. As a result, the risk of surrogate identifier 314 exposing the identity of the user can be mitigated.

Moreover, live event data 304 stores data representing a history of events associated with the user with respect to time. In the example of FIG. 3, live event data 304 can include entries 322 and 324. Each of entries 322 and 324 can be structured according to a particular format, with various pre-determined fields representing different information of events. For example, each of entries 322 and 324 may include a time stamp field 326, an action field 328, an action content field 330, and a post identifier (ID) field 332. Time stamp field 326 may store a time stamp associated with the events represented by entries 322 and 324. Action field 328 may store data related to an action associated with the events (e.g., posting of content, visiting of a web page, etc.). Action content 330 may store content information of the action specified in action 328 (e.g., the content posted, the web page visited, etc.). Post ID 332 field may store an identifier associated with the content posted. In the example of FIG. 3, entry 322 may correspond to the posting of content by the user John A as shown in FIG. 2, and stores time stamp 206 at time stamp field 326 and post content 208 at action content field 330.

The storage of structured event data allows a user (or a party authorized by the user) to search for specific event information, or PII, that is associated with a particular time stamp for various purposes. For example, from live data storage 160, the user (or the authorized party) can search for a link the user has previously visited, a post the user has previously made, etc., and edit (e.g., delete, modify, etc.) the link or the post in the record. The user can perform the search by searching a particular field (e.g., action field 328, action content field 330, etc.) to obtain the information. Because data structure 300 provides easy access to information that may contain PII, live data storage 160 may be accessible only by the user (or by the authorized party). Moreover, social networking system 100 may also remove user profile 302 as well as live event data 304 associated with a particular user from live data storage 160, based on a request from that user.

Referring back to FIG. 1, social networking system 100 may also include a log data storage 170. Log data storage 170 can provide bulk data storage derived from the data stored in live data storage 160. For example, log data storage 170 can store log data representing a log of events on a particular web site (e.g., a user visiting the web site, posting comments on the web site, etc.) as well as some user-identifiable information associated with the events (e.g., information about the users who generated the events, other context information associated with the events, etc.), derived from profile 302 and live event data 304 of different users. The log data may be provided to a third party for other applications, such as performing data analytics such as, for example, determining a demographical trend of usage of the web site.

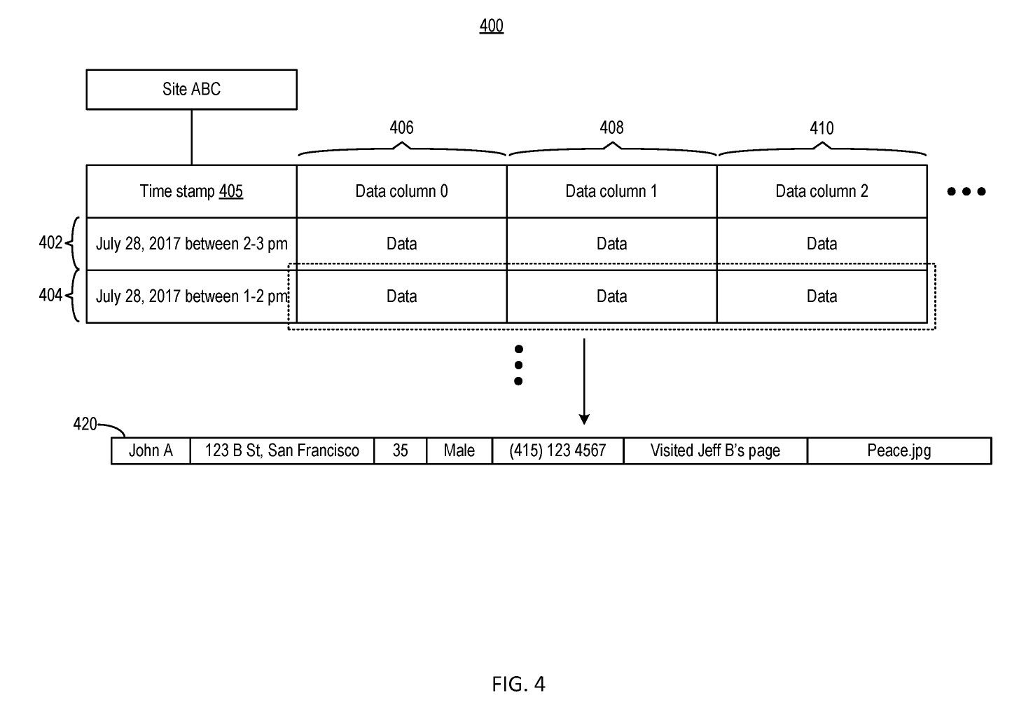

Reference is now made to FIG. 4, which illustrates an example data structure 400 stored in log data storage 170 according to aspects of the present disclosure. As shown in FIG. 4, data structure 400 can include a two-dimensional table. The two-dimensional table may store a stream of log data, such as log data stream 420, associated with a web site. The information included in the log data stream may be associated with various events that occur on the web site, and may vary depending on the target application of the log data. For example, to provide insight on the traffic pattern for a web site, the event data stored in data structure 400 may include, for example, information of users who has visited the web site within a particular time range. As another example, to provide insight on users' web browsing habits related to a particular web site, the event data stored in data structure 400 may include, for example, activities performed by the users on the web site, other activities performed by the users before and after visiting the web site, etc. In the example of FIG. 4, the log data stream may include information from profile 302, as well as live event data included in entries 322 and 324. The two-dimensional table may include a plurality of rows (e.g., rows 402, 404, etc.). Each row may be associated with a time stamp range 405, and may store a portion of the log data stream that corresponds to the associated time stamp range. The portion of the event data in a row can also be further partitioned into a set of data columns (e.g., columns 406, 408, 410, etc.). As to be discussed in more detail below, the partitioning of the event data into rows and columns can facilitate further processing of the event data.

As shown in FIG. 4, log data stream 420 may include PII. For example, the user name, the address, the phone number, the posted content, etc., can be used to identify and/or contact the user. Moreover, a set of activities performed by the user prior to or after visiting the web site may also provide context information for identifying the user (or other users). For example, in the example of FIG. 4, the log data stream includes a record of the user (John A) visiting a web page associated with another user (Jeff B). That record may provide PII of another user (Jeff B). Moreover, the record may be combined with other information to identify the user John A. For example, it is possible to use John A's visit to Jeff B's web page as a starting point to determine a group of users connected with Jeff B in social networking system 100 (e.g., through the edge stores). If John A is connected with Jeff B and is within the group, it may be possible to deduce that log stream 420 is associated with John A when combining with other information, whether or not the user name “John A” is in the log stream.

Given that some of the user-identifiable information and content data stored in bulk data storage may include PII, and that the data may be made available to a third party for performing data analytics, social networking system 100 may perform a set of de-identification processing on this data based on a pre-determined privacy policy. Referring back to FIG. 1, data center(s) 130 may further include a log data processing module 180 to perform the de-identification processing. Based on the pre-determined privacy policy, log data processing module 180 can complete the de-identification processing on the log data stream stored in log data storage 170 within a predetermined period (e.g., 90 days) from the creation of a new log data stream, or from the time when a request from the user (e.g., account removal) is received.

The de-identification processing may include two components—the detection of PII (or potential PII) in the log data, and the editing of the identified PII to reduce the likelihood that the edited data can be used to identify, contact, or locate a single person, or to identify the person in context. The detection of PII can be performed by a PII detector, which can be a software parser (which can be part of log data processing module 180), and may rely on some degree of human input and supervision. The PII detector may be configured to perform the PII detection based on a set of rules. For example, the PII detector may search for a pre-determined data pattern, a pre-determined data attribute, etc. in the log data, and determine that the log data is likely to contain PII when the pre-determined data pattern and/or attribute is found.

The PII detector can be configured to detect various pre-determined data patterns for PII detection. One example of pre-determined data pattern is a numerical schema. For example, as discussed above, phone numbers may be regarded as PII. Phone numbers, depending on the locale, may include a set number of digits, with the first few digits being associated with a country code, an area code, etc. Therefore, a set of numbers included in the log data can be identified as phone numbers, if the set of numbers includes a recognizable combination of country code and area code. As another example, credit card numbers from a credit card vendor may be associated with a checksum specific for that credit card vendor. Therefore, a set of numbers included in the log data can be identified as credit card numbers if they satisfy the aforementioned checksum.

Besides numerical schemas, PII may also be detected based on some other data patterns. For example, as discussed above, content posted by a user may be regarded as PII. Posted content may be identifiable from the log data if the posted content includes a pre-determined set of non-American Standard Code for Information Interchange (non-ASCII) codes, especially for content posted by international users. Posted content may also be identifiable from the log data based on other data patterns including, for example, characters (English or not) associated with a name, non-ASCII codes not associated with any particular text characters (which may indicate that the data is part of a media data file), etc.

Besides data patterns, PII may also be detected based on other pre-determined attributes. For example, PII may be detected based on detection of a specific data type or structure associated with PII. As an example, some identifiers used for identifying a user can be based on a specific data type, which comprises a specific combination of characters and numbers. Such identifiers can be detected from the log data, if the specific combination of characters and numbers is found. As another example, some de-packaged structured data (e.g., a data object based on JavaScript Object Notation (JSON)) in the log data may be known to include PII (e.g., JSON objects of a user profile). Based on the detection of de-packaged JSON data objects in the log data (e.g., by detecting data schema associated with JSON Data object), it can be determined that the data corresponding to the de-packaged JSON data objects is likely to include PII.

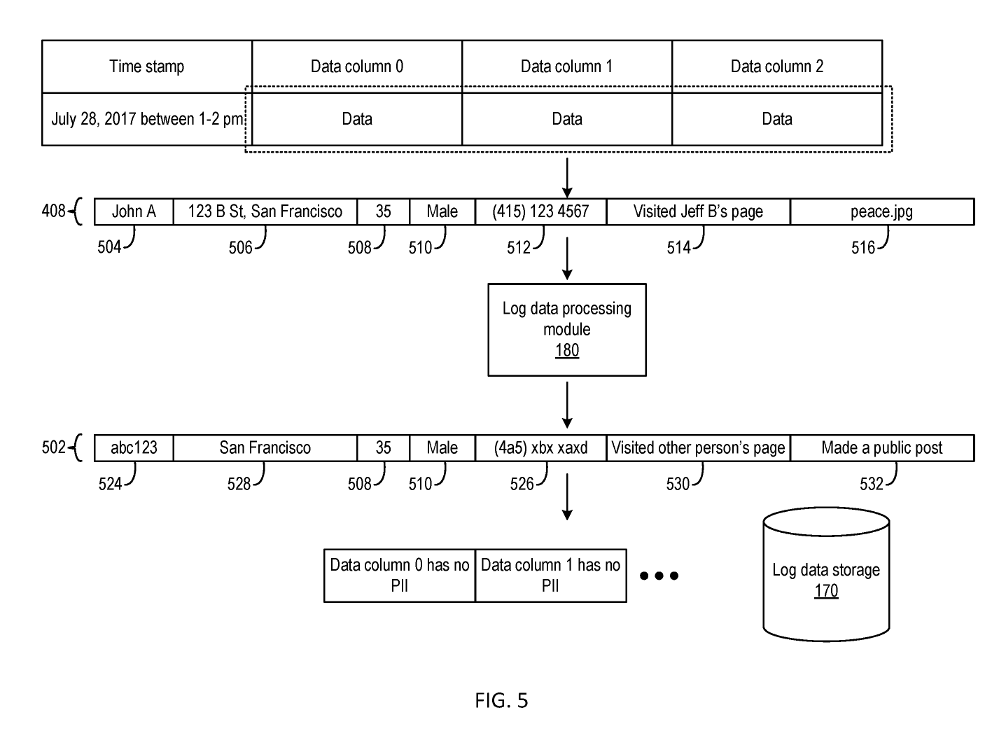

Based on the detection of the PII in the log data, log data processing module 180 may edit some or all of the log data stream based on a set of pre-determined policies, as part of a de-identification processing. For example, the identified PII may be replaced with a less sensitive version of the information, yet the less sensitive version may still be useful for other applications (e.g., to perform data analytics, to generate information targeted at a user or a group of users, etc.). Reference is now made to FIG. 5, which illustrates an example of de-identification processing on the log data stream stored in log data storage 170, according to aspects of the present disclosure. In the example of FIG. 5, log data processing module 180 can edit log data stream 420 of FIG. 4 to remove and/or replace some of the information determined to be PII. For example, log data stream 420 may include a user name 504, an address 506, an age 508, gender 510, phone number 512, prior activity 514, and posted content 516. As part of the processing, log data processing module 180 may selectively process information that is determined to be PII, such as user name 504, address 506, phone number 512, prior activity 514, and posted content 516. Log data processing module 180 may retain the information included in age 508 and gender 510 based on a determination that this information is not PII. Log data processing module 180 can generate a log data stream 502 based on the edited information, and replace log data stream 420 with log data stream 502 in log data storage 170.

As for the information that is determined to be PII, log data processing module 180 may apply various kinds of techniques to perform the de-identification processing. As an example, as shown in FIG. 5, log data processing module 180 may replace user name 504 with a surrogate identifier 524. As discussed above, a mapping between a user name and a surrogate identifier can be stored in the user profile. Therefore, as long as the user profile exists, a party with authorized access to the user profile may still be able to determine the identity of the user associated with the log data stream, and can use the event data for other purposes (e.g., to push a service or content targeted at the user, to perform data analytics for that user, etc.). However, if the user profile has been removed, it will become difficult to determine the identity of the user based on the surrogate identifier. As another example of de-identification processing, log data processing module 180 can obfuscate and/or scramble information determined to be PII. In the example of FIG. 5, log data processing module 180 can replace phone number 512 with a scrambled set 526. The scrambling can be based on, for example, a set of keys stored in the user profile, such that scrambled set 526 can be de-scrambled to obtain phone number 512 by a party with access to the user profile. Just as the use of surrogate identifier, for a party without access to the user profile, or in a case where the user profile has been removed, it will become very difficult (if not impossible) to determine the user's phone number from the scrambled set.

Log data processing module 180 may apply other techniques to perform the de-identification processing, such as replacing some of the PII with information that is less sensitive yet is still useful for other purposes. For example, log data processing module 180 may replace the full address information (with street number, street name, and city name) included in address 506 with a simplified address 528 that includes just the city name. Also, in lieu of prior activity 514 that includes user-identifiable information (e.g., visited Jeff B's page), log data processing module 180 can put in generalized prior activity 530 such as, for example, “a visit to other person's page.” Similarly, in lieu of posted content 516 which includes specific information about the content (e.g., the name of the file), log data processing module 180 can put in generalized posted content such as, for example, “made a public post.” All this replacement information may be non-PII, yet they still can be used for other purposes. For example, data analytics can still be performed on the log data stream 502 to determine a number of visitors of a web page who are associated with a particular demographic group, made a public post, visited other people's page, live in a particular city, etc.

In some embodiments, to facilitate the de-identification processing, log data processing module 180 may apply the processing based on data columns as described in FIG. 4. Each data column can be processed by a PII detector to identify PII included in the data column. After identifying PII, the PII detector can provide the information of the identified PII (e.g., which row and column contains the PII, the byte location of the PII, etc.) to log data processing module 180 to perform de-identification processing based on the techniques described above. Multiple data columns can be examined and processed concurrently by multiple PII detectors and multiple instances of log data processing module 180. The de-identification processing of a data column may complete when, for example, the PII detector determines that the data column is free of PII. During or after the de-identification processing of a data column, a characterization report can be generated for a data column to indicate absence or presence of PII in the data column, and/or a number of PII items present in the data column. The characterization information can be stored as metadata in log data storage 170, together with the processed data column.

### II. Machine-Learning Assisted De-Identification

As described above, due to the increasing popularity of online systems, the online systems may maintain significant amounts of user-identifiable information as well as communication records containing PII, which can be stored as log data in log data storage 170. Even with large amount of human and computing resources being deployed for the examination of the log data, it may still be possible that some of the PII in the log data are not identified and processed. This can pose privacy risks to the users.

Machine-learning (ML) or artificial intelligence (AI)-based techniques may be used to assist in the aforementioned de-identification processing. More specifically, the system can isolate a partition of a log data column that has previously been subject to the de-identification processing. The log data column may be associated with a prior characterization of absence or presence of PII in the data column. The system can process the partition with a ML-based classifier to generate a latest characterization. The system can compare the prior characterization against the latest characterization, and can determine an action based on the comparison result. As an example, if the system determines that the prior characterization indicates the partition is free of PII, but the latest characterization indicates the partition includes potential PII. Based on this determination, the system may update the set of rules based on which of the prior characterizations was made, and rerun the PII detection and de-identification processing of the partition (and/or other log data stored in log data storage 170). In a case where the prior characterization was generated by a human detector, the system may also transmit a notification to the human detector indicating the potential error in PII examination, to prompt the human detector to rerun the PII examination. The system may also disable access to the partition of log data, or even remove the partition of log data from log data storage 170, if the system does not receive a confirmation that a new characterization of the data column including the partition has been performed, and a confirmation that the data column is free of PII.

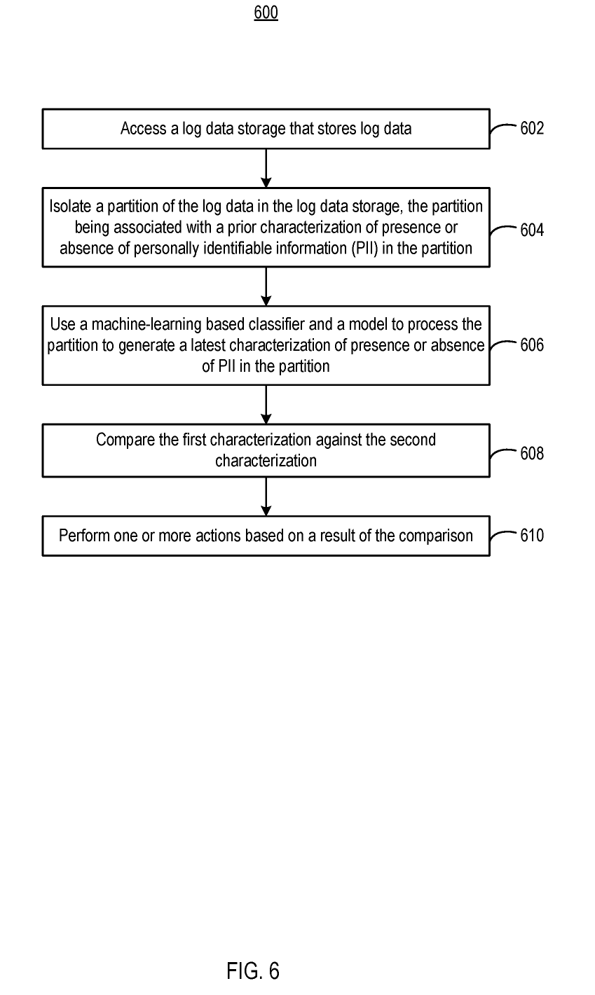

FIG. 6 is a simplified flowchart illustrating an example method 600 of processing PII, according to certain aspects of the present disclosure. At 602, a system (e.g., data center(s) 130, or other components of social network host 100) may access a log data storage (e.g., log data storage 170). The log data may include a cumulative history of events on a web site up from a time point of creation (e.g., when the log data was first stored) to a current time point. The log data can be partitioned or structured into multiple dimensions. For example, as shown in FIG. 4, the log data can be partitioned into a set of data columns and a set of rows. The set of rows may correspond to a set of time stamps between the time point of creation and the current time point, with the log data partitioned among the set of rows based on the time stamps.

At 604, the system may isolate a partition of the log data in the log data. The partition may include log data of a data column (or part of a data column) that spans a number of rows. The partition can be associated with a prior characterization of presence or absence of PII. The prior characterization information may be obtained from, for example, meta data of the data columns stored in log data storage 170.

In some embodiments, the accessing of the log data storage, as well as the isolation of the partition of log data from the log data storage, can be triggered by an event. For example, based on a pre-determined policy, the aforementioned de-identification process of log data stored in log data storage 170 is to be completed within a pre-determined time period (e.g., 90 days) after the log data is created or stored in the storage. To implement such a policy, a number of timing milestones can be set to gauge the progress of the de-identification process, and each timing milestone can trigger the processing of a certain partition of the log data with method 600.

At 606, the system may use a machine-learning based classifier, and a prediction model, to process the partition. The processing can generate a latest characterization of absence or presence of PII in the partition. As discussed above, the detection of PII can be based on a set of rules. A prediction model can also be constructed and trained using data samples that are labelled as PII based on the set of rules, or a set of updated rules. The ML-based classifier can then use the prediction model to process the log data partition, to predict whether the log data partition includes PII. As to be discussed in more details below, various techniques can be used to construct the prediction model, such as decision tree, bloom filter, uniqueness of things, average length, boundary check, etc. The prediction model can also be trained using some of the log data from log data storage 170 that have been labelled PII. The classifier can then use the trained prediction model to process the partition, to predict whether PII is absent or present in the partition. The prediction result can be part of the latest characterization of the partition.

In operation 608, the system may compare the prior characterization (obtained in operation 604 as part of meta data) against the latest characterization (generated in operation 606 using the ML-based classifier), to look for discrepancies. For example, the system may determine whether the ML-based classifier predicts that the partition includes PII, while the prior characterization indicates that the partition is free of PII. As another example, the system may compare a number of potential PII predicted by the ML-based classifier versus a number of PIIs reported in the prior characterization (assuming the de-identification process on the partition is not yet complete).

In operation 610, based on a result of the comparison in operation 608, the system may perform one or more actions. For example, the prior characterization may have been obtained based on an older set of rules. The system may update the set of rules based on the model. For example, if the model includes definitions for a new data pattern, a new data type, a new data structure, etc., from training, the set of rules can be updated to include these definitions. In a case where the PII examination is performed by a software application (e.g., a crawler, a parser, etc.), the system may also trigger the software application to rerun PII examination on some (or all) of the previously-processed log data to identify additional PII (if any), and perform the aforementioned de-identification processing on the identified PII. In a case where the PII examination is performed by a human detector, the system may also transmit notification to the human detector who generated the prior characterization about the prediction result, to alert the human detector to rerun PII examination (based on either the original or the updated set of rules). On the other hand, if the result of the comparison shows no discrepancy between the prior characterization and the latest characterization, or the discrepancy is within a tolerable range (which may indicate that the predicted PII is noise), the system may stop processing of the partition, and move on to process the next partition of log data.

The system may also perform one or more follow-up actions after operation 610. For example, in a case where the system does not receive an updated characterization from the software application, or a response from the human detector, the system may perform additional actions to mitigate privacy risks. For example, if the system fails to receive a response within a predetermined period, the system may disable access to the partition of log data, and/or remove the partition of log data from log data storage 170.

### III. System for Machine-Learning Assisted De-Identification

The method described above with respect to FIG. 6 may be perform by a social network host, such as a server that may perform a machine learning-based characterization or classification, and may determine and perform corresponding actions as described below.

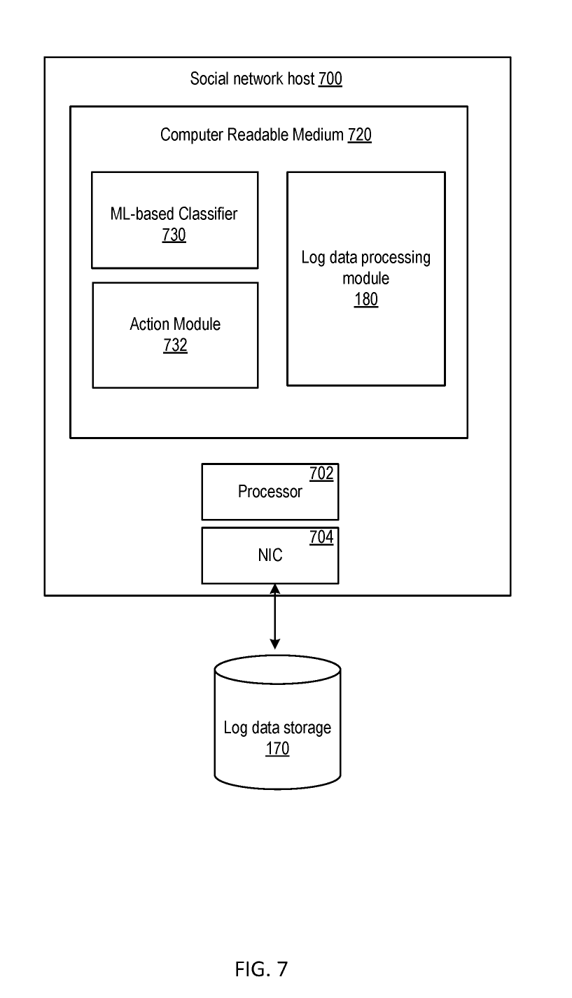

FIG. 7 is a simplified block diagram illustrating a social network host 700 for implementing some of the examples disclosed herein. Social network host 700 may include one or more processors 702, a network interface card (NIC) 704, and computer readable medium 720 that stores a ML-based classifier 730, an action module 732, as well as log data processing module 180 of FIG. 1. Social network host 700 can be part of social network host 110 of FIG. 1.

Processor(s) 702 may include any suitable processing device or any combination of such devices. An exemplary processor may comprise one or more microprocessors working together to accomplish a desired function. The processor may include a central processing unit (CPU) that comprises at least one high-speed data processor adequate to execute program components for executing user and/or system-generated requests.

NIC 704 may provide a communication interface from social network host 700 to user devices via one or more communication networks, including local area networks (LANs), wide area networks (WANs) (e.g., the Internet), and various wireless telecommunications networks. NIC 704 may comprise Ethernet cards, Asynchronous Transfer Mode NICs, Token Ring NICs, wireless network interface controllers (WNICs), wireless network adapters, and the like. NIC 704 may facilitate transmission and receipt of the input content to the social networking system.

Computer readable medium 720 may be any suitable device or devices that can store electronic data. A computer readable medium may be embodied by one or more memory devices, including a working memory, which may include a random access memory (RAM) or read-only memory (ROM) device. Examples of memory devices may include memory chips, disk drives, etc. Such memory devices may operate using any suitable electrical, optical, and/or magnetic mode of operation. Computer readable medium 720 may comprise a non-transitory computer-readable storage medium that stores a plurality of instructions executable by one or more processors 702. The plurality of instructions, when executed by one or more processors 702, may cause one or more processors 702 to perform any of the methods described herein.

A. ML-Based Classifier

Social network host 700 may include ML-based classifier 730 stored in computer readable medium 720 and may be loaded to a memory (e.g., a RAM such as synchronous dynamic random-access memory (SDRAM)) during run time. ML-based classifier 730 may process a partition of log data (e.g., the most recent log data in a column) stored in log data storage 170 with a prediction model, to generate a prediction of whether the partition is likely to include PII, and to identify the data in the partition that are likely to be PII.

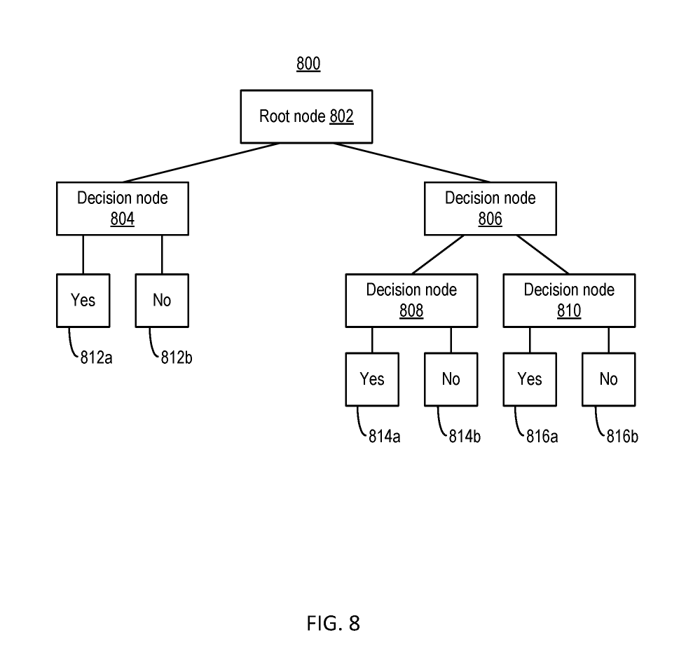

As discussed above, a prediction model can be constructed and trained from data samples that are labelled as PII. ML-based classifier 730 can use the prediction model to process the log data partition, to predict whether the log data partition includes PII. Various techniques can be used to construct or to train a prediction model. One example of a prediction model is a decision tree, which can generate a prediction decision based on attributes of an input. FIG. 8 illustrates an example of a prediction tree 800 which can be part of ML-based classifier 730 according to certain aspects of the present disclosure. As shown in FIG. 8, prediction tree 800 includes a root node 802 and a set of decision nodes 804, 806, 808, and 810. Some of the decision nodes may include a set of leaf nodes. For example, decision node 804 includes leaf nodes 812a and 812b, decision node 808 includes leaf nodes 814a and 814b, whereas decision node 810 includes leaf nodes 816a and 816b. Each leaf node can be associated with a prediction decision of prediction tree 800 (“yes” or “no”). A decision can be made based on selecting a path from root node 802 via the decision nodes to one of the leaf nodes. To begin with, root node 802 can process the input and select one of the decision nodes 804 or 806. The selected decision node then processes the input and selects the next level node, which can be another decision node, or a leaf node. Ultimately one of the leaf nodes 812, 814, or 816 will be reached, and a prediction decision corresponding one of the leaf nodes can be provided as an output of decision tree 800.

Decision tree 800 can be constructed based on a set of training data. As an illustrative example, decision tree 800 can be constructed for predicting whether a set of numbers is PII. The decision tree can be constructed based on a set of training data including sets of numbers labelled as PII and sets of numbers labelled as non-PII. Both sets of numbers can be associated with a set of attributes, and a prediction decision (to predict whether a set of numbers is PII) can be made based on a set of distinguishing attributes. One example of the attributes can be set length. For example, numbers that can carry PII (e.g., phone numbers, credit cards, etc.) may include specific set lengths (e.g., a set length of 9 for United States phone numbers, a set length of 16 for certain credit card numbers, etc.). Another example of the attributes can be various numeric patterns specific for different types of PII. For example, phone numbers may include country codes and area codes, both of which include specific and known numeric patterns.

Decision tree 800 can be configured to decide whether an input set of numbers is PII (e.g., whether the input set of numbers is a phone number) based on a set of distinguishing attributes, which can correspond to a set of decision nodes. The set of distinguishing attributes can be determined by recursive partitioning of the set of training data into subsets. To perform the partitioning, one or more attributes can be selected as candidate distinguishing attributes, and the input set of numbers can be partitioned into subsets based on whether they possess the candidate distinguishing attributes. As an example, the candidate distinguishing attributes can be a set length to determine whether an input set of numbers is a United States phone number, which can be regarded as PII. Entropy calculations can then be performed based on a distribution of PII and non-PII for each subset of numbers, to determine the homogeneity for each subset (e.g., complete homogeneity when a subset contains entirely PIIs or non-PIIs, low homogeneity when a subset contains an even mixture of both). The sum of entropies of each subset can be compared against the entropy of the input set of numbers to determine an entropy difference. The candidate distinguishing attribute that gives rise to the maximum entropy difference can be set as a decision node. The subsets can be recursively partitioned based on other distinguishing attributes (e.g., whether the input set of numbers includes a pattern that matches an area code) and entropy difference determination, until each subset is completely homogenous. The decision tree, and in particular the decision nodes included in the decision tree, can then be used to process numerical data in the log data to determine whether the log data includes a phone number, which can provide an indication of whether the log data includes PII.

Another example of a prediction model is a bloom filter. A bloom filter is a data structure that can store information related to a set of known PII. By determining whether an input is part of the set, a bloom filter can provide a prediction about whether the input is PII. The bloom filter may be designed to favor false positive predictions. For example, if the input is determined to be not in the set, it is likely that the input is not PII. On the other hand, if the input is determined to be in the set and predicted to be PII, there is considerable likelihood that the prediction is false. Such an arrangement may be designed to provide a more rigorous identification of PII from the log data, to reduce the likelihood of skipping log data that could have been identified to be PII.

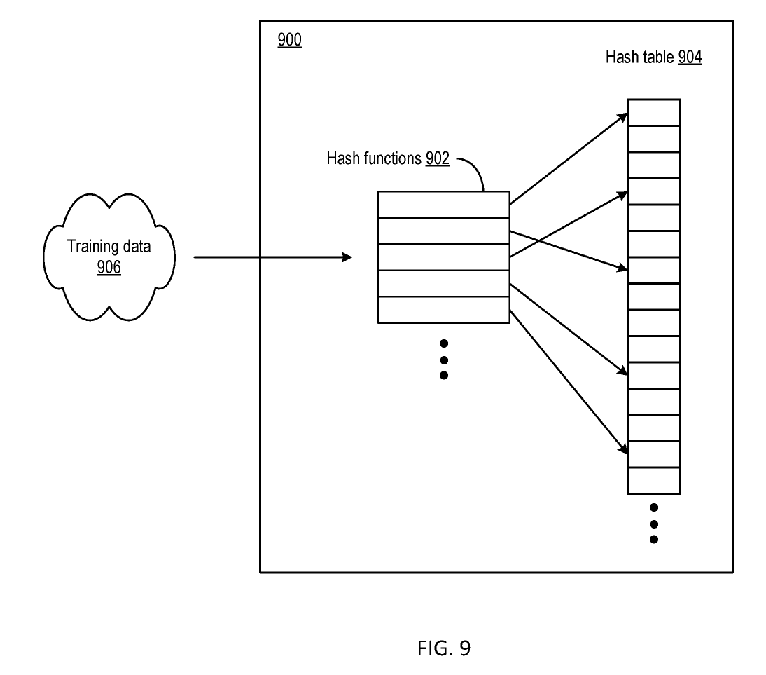

There are various ways of constructing a bloom filter. FIG. 9 illustrates an example of a bloom filter 900 which can be part of ML-based classifier 730 according to certain aspects of the disclosure. As shown in FIG. 9, bloom filter 900 includes a set of hash functions 902 and a hash table 904. Bloom filter 900 can be constructed by inputting a set of training data 906 with PII (e.g., phone numbers, addresses, names, non-ASCII codes, etc.) through hash functions 902 to generate a set of hash values. The hash values can be stored in hash table 904 in various ways. For example, an index address of hash table 904 can be computed for each hash value. A hash value can be stored in an entry of hash table 904 associated with the index address computed based on the hash value. With such an arrangement, multiple hash values can be generated from a PII item (e.g., a phone number) using hash functions 902, and can be stored in one or more entries of hash table 904.

To predict whether an input is PII with bloom filter 900, the input information (e.g., a set of numbers, characters, or a combination of both) can be processed with hash functions 902 to generate a set of input hash values. Bloom filter 900 can then determine whether the input hash values are stored in hash table 904. For example, bloom filter 900 can generate a set of address indices from the input hash values. For each entry corresponding to each of the set of address indices, bloom filter 900 can determine whether the entry is empty, or whether the entry stores a hash value that matches any of the set of hash values. If at least one of the set of input hash values can be found in hash table 904, bloom filter 900 can output an indication that the information may be PII. On the other hand, if none of the input hash values can be found in hash table 904, bloom filter 900 can output an indication that the input information is unlikely to be PII.

Besides decision trees and bloom filters, other machine learning techniques may also be used to construct the prediction model. For example, Naive Bayes, Neural Networks, Support Vector Machines (SVM), and k-Nearest Neighbor (KNN) may be used to generate the prediction model. Moreover, other techniques such as uniqueness of things, average length, boundary check, etc. can also be used to perform the prediction.

After the aforementioned prediction models are constructed, they can be trained regularly with the latest actual log data to improve the accuracy of prediction. For example, for every two weeks, a pre-determined number of rows of log data (whether or not they have been previously subject to de-identification processing) associated with the most recent time stamps can be selected in log data storage 170 as new training data. Samples of PII can be identified from the selected log data, and can be used to train and/or update the aforementioned prediction model. For example, the new training data can be added to the previous training data used to construct decision tree 800. The aforementioned partitioning processing can be performed on the updated set of training data based on entropy calculations to determine a new set of distinguishing attributes associated with the decision nodes. Moreover, the new training data can also be added to the previous training data used to construct bloom filter 900, where additional hash values can be generated from the new training data and stored in hash table 904.

B. Action Module

Action module 732 can perform one or more actions based on the prediction output by ML-based classifier 730 to facilitate the de-identification processing of log data. As discussed above, as part of a de-identification process, a system (e.g., data center(s) 130, or other components of social network host 100) may isolate a partition of a log data column in log data storage 170. The partition had been subject to a prior de-identification processing by log data processing module 180, and the log data column (from which the partition is isolated) can be associated with metadata indicating, for example, that the log data column is free of PII. The system can validate the prior de-identification processing by processing the partition using a ML-based classifier (e.g., ML-based classifier 730) to generate a prediction of absence or presence of PII in the partition. If, based on the prediction, the system determines that one or more PII in the log data partition have not been identified and hence not subject to de-identification processing, action module 732 may perform one or more actions to mitigate the risk of exposing potential PII.

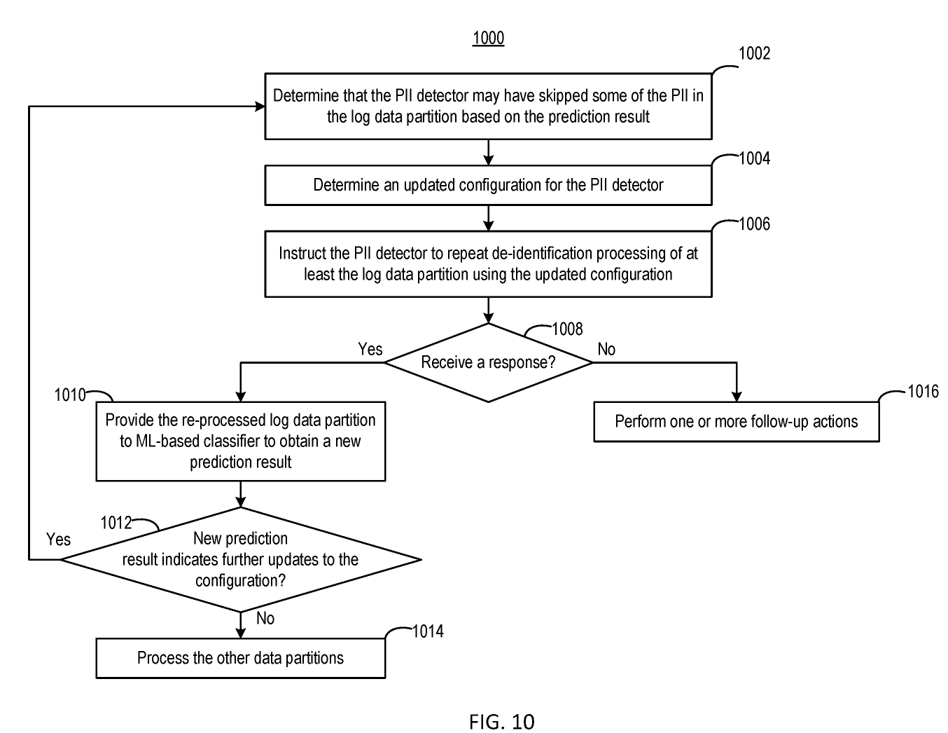

Reference is now made to FIG. 10, which is a simplified flowchart illustrating an example method 1000 which can be performed by action module 732, according to certain aspects of the present disclosure. Method 1000 can be part of operation 610 of FIG. 6. At 1002, action module 732 determines, based on the prediction result from ML-classifier 730, that the PII detector may have skipped some of the PII in the log data partition. At 1004, action module 732 may determine an updated configuration for the PII detector. For example, as part of the process of training and/or updating the prediction models of ML-based classifier 730, action module 732 may receive definition information of a new data pattern, a new data type, a new data structure, etc., associated with the training data. Action module 732 can provide the definition information to the PII detector to update the rules for PII detection.

At 1006, action module 732 may instruct the PII detector to repeat the de-identification processing of at least the log data partition, as well as some other log data, using the updated configuration (e.g., the updated set of rules for PII detection). Action module 732 may receive a response including the re-processed log data partition, and a characterization of absence of PII in the re-processed log data partition, at 1008. Action module 732 may provide the re-processed log data partition to ML-based classifier 730 to obtain a new prediction result, at 1010. Action module 732 may determine whether the new prediction result indicates further updates to the configuration, at 1012. The determination can be based on, for example, whether the new prediction result indicates that there are still PII remaining in the re-processed log data partition, or that the quantity of PII exceeds the level considered to be noise. If the new prediction result indicates further updates to the configuration (at 1012), action module 732 can proceed back to 1002 to repeat the updating of the configuration. On the other hand, if the new prediction result indicates no further update to the configuration is needed (at 1012), action module 732 can proceed to 1014 to validate the de-identification processing of other log data partitions.

Referring back to 1008, if a response has not been received within a predetermined time after 1006 is performed, action module 732 can perform one or more follow-up actions at 1016. For example, as part of the follow-up actions, the system may disable access to the partition of log data, and/or remove the partition of log data from log data storage 170, to mitigate privacy risk posted by the remaining PII in the log data.

In some embodiments, as part of 1014 or 1016, action module 732 may also determine to bypass the PII detector and use ML-based classifier 730 to generate prediction of PII for other log data partitions, and instruct log data processing module 180 to perform de-identification processing based on the prediction result of ML-based classifier 730.

Example Computing System

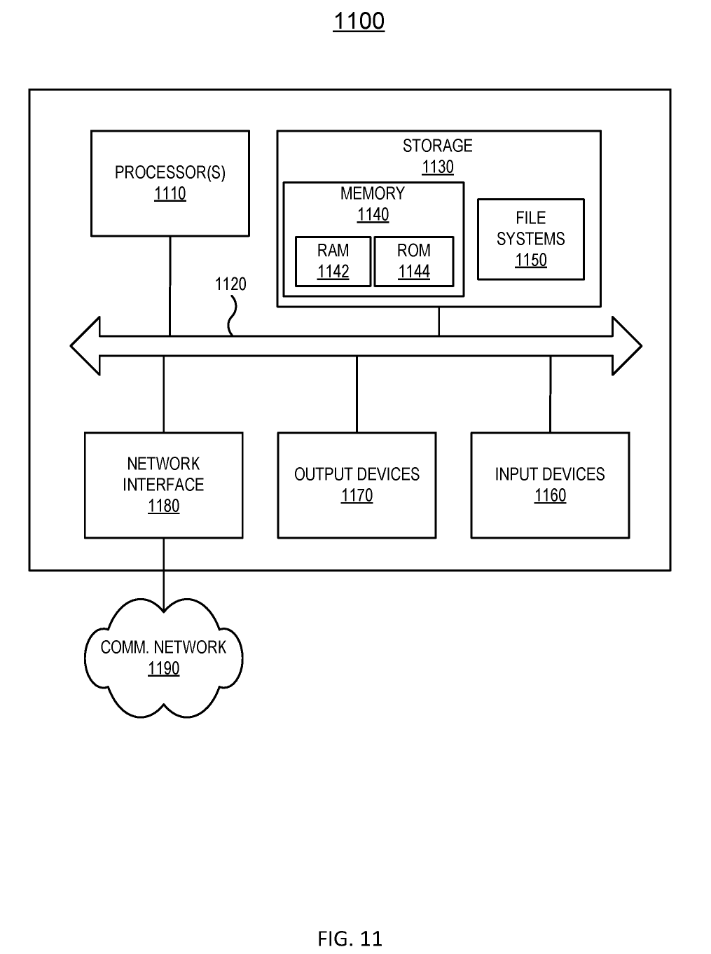

FIG. 11 illustrates an example of a block diagram of a computing system. The computing system shown in FIG. 11 can be used to implement any computing device described herein in replacement of or to supplement to the descriptions provided. In this example, computing system 1100 includes processor 1110, bus 1120, storage 1130, memory 1140, random access memory (RAM) 1142, read-only memory (ROM) 1144, file systems 1150, user input device 1160, output devices 1170, network interface 1180, and communication network 1190. In the present example, user input device 1160 is typically embodied as a computer mouse, a trackball, a track pad, a joystick, wireless remote, drawing tablet, voice command system, eye tracking system, and the like. User input device 1160 typically allows a user to select objects, icons, text and the like that appear on output devices 1170 via a command such as a click of a button or the like. Output devices 1170 may include a screen associated with a computing device, virtual reality environment, projection system, speaker, and the like.

Examples of network interfaces 1180 typically include an Ethernet card, a modem (telephone, satellite, cable, Integrated Services Digital Network (ISDN)), an asynchronous digital subscriber line (DSL) unit, FireWire® interface, universal serial bus (USB) interface, and the like. For example, network interfaces 1180 may be coupled to communication network 1190, to a FireWire® bus, or the like. In other embodiments, network interfaces 1180 may be physically integrated on the processor 1110, may be a software program, such as soft Digital Subscriber Line (DSL), or the like.

In various examples, computing system 1100 typically includes familiar computer components such as processor 1110 and memory 1140 devices, such as RAM 1142, ROM 1144, file systems 1150, and system bus 1120 interconnecting the above components.

RAM 1142 and ROM 1144 are examples of tangible, non-transitory media configured to store data such as embodiments of the present disclosure (e.g., methods 600 and 1000, log data processing module 180, ML-based classifier 730 and action module 732, decision tree 800, bloom filter 900, etc.) including executable computer code, human readable code, or the like. Other types of tangible media include floppy disks, removable hard disks, optical storage media such as CD-ROMS, DVDs and bar codes, semiconductor memories such as flash memories, battery-backed volatile memories, networked storage devices, and the like.

In various examples, computing system 1100 may also include software that enables communications over a network such as Hypertext Transfer Protocol (HTTP), Transmission Control Protocol/Internet Protocol (TCP/IP), Real-Time Streaming Protocol (RTP/RTSP), and the like. In alternative embodiments of the present disclosure, other communications software and transfer protocols may also be used, for example Internetwork Packet Exchange (IPX), User Datagram Protocol (UDP), or the like.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Also, it is noted that individual examples may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some examples, the systems may be configured as a distributed system where one or more components of the system are distributed across one or more networks such as in a cloud computing system.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including, but not limited to, conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A computer-implemented method of processing personally identifiable information (PII), comprising:
accessing a log data storage that stores log data, wherein the log data is structured into multiple dimensions;
isolating a partition of the log data in the log data storage, wherein the partition is associated with one dimension of the multiple dimensions and is associated with a first characterization of presence or absence of PII in the partition;
processing, using a machine-learning (ML) based classifier and based on a model, the partition to generate a second characterization of presence or absence of PII in the partition;
comparing the first characterization against the second characterization; and
based on a result of the comparison, performing one or more actions.

2. The method of claim 1, wherein the log data is structured into two dimensions comprising a set of rows and a set of columns, wherein the partition is isolated from a column of the set of columns.

3. The method of claim 2, wherein the set of rows is associated with a set of timestamps.

4. The method of claim 1, wherein the model comprises a decision tree constructed based on partitioning a set of training log data into subsets and performing entropy calculations on the subsets;
wherein the second characterization is generated based on one or more decisions from the decision tree.

5. The method of claim 1, wherein the model comprises a bloom filter constructed based on a first set of hash values generated from a set of training log data labelled as PII using a set of hash functions;
wherein processing the partition to generate the second characterization of presence or absence of PII in the partition comprises:
generating a second set of hash values from the partition using the set of hash functions, and
determining the second characterization based on whether the second set of hash values is included in the first set of hash values.

6. The method of claim 1, wherein the one or more actions comprise:
updating a set of rules associated with the generation of the first characterization, wherein the set of rules includes a set of pre-determined data patterns associated with PII.

7. The method of claim 6, wherein the pre-determined data patterns comprise at least one of: a predetermined numeric schema, a pre-determined group of American Standard Code for Information Interchange (ASCII) codes, or a pre-determined data type associated with PII.

8. The method of claim 6, wherein the one or more actions comprise:
identifying one or more PII from the partition based on the updated set of rules; and
de-identifying the one or more PII.

9. The method of claim 8, wherein de-identifying the one or more PII comprises: obfuscating the one or more PII in the partition.

10. The method of claim 8, wherein de-identifying the one or more PII comprises:
determining that a first identifier included in the partition to be PII;
determining, based on the first identifier, a second identifier that is determined to be non-PII; and
replacing the first identifier with the second identifier in the partition.

11. The method of claim 1, wherein the one or more actions comprise:
transmitting a notification to a generator of the first characterization;
monitoring for a response from the generator after transmitting the notification; and
based on a determination that the response has not been received before a pre-determined time, making at least the partition inaccessible to the generator.

12. The method of claim 11, wherein the generator is a human administrator.

13. The method of claim 1, further comprising:
receiving a triggering event;
wherein the partition is processed to generate the second characterization based on the reception of the triggering event.

14. The method of claim 13, wherein the triggering event comprises an expiration event of a timer, wherein the timer is started when the partition is first created in the log data storage.

15. The method of claim 1, wherein the partition is a first partition, further comprising:
isolating a second partition of the log data in the log data storage; and
processing, using the ML based classifier and based on the model, the second partition to generate a third characterization of presence or absence of PII in the second partition.

16. A system comprising:
one or more processors; and
a non-transitory computer-readable medium storing instructions that, when executed by the one or more processors, cause the one or more processors to perform operations including:
accessing a log data storage that stores log data, wherein the log data is structured into multiple dimensions;
isolating a partition of the log data in the log data storage, wherein the partition is associated with one dimension of the multiple dimensions and is associated with a first characterization of presence or absence of personally identifiable information (PII) in the partition;
processing, using a machine-learning (ML) based classifier and based on a model, the partition to generate a second characterization of presence or absence of PII in the partition;
comparing the first characterization against the second characterization; and
based on a result of the comparison, performing one or more actions.

17. The system of claim 16, wherein:
the log data is structured into two dimensions comprising a set of rows and a set of columns;
the partition is isolated from a column of the set of columns; and
the set of rows is associated with a set of timestamps.

18. The system of claim 16, wherein the model comprises at least one of: a decision tree constructed based on partitioning a set of training log data into subsets and performing entropy calculations on the subsets, or a bloom filter constructed based on a first set of hash values generated from a set of training log data labelled as PII using a set of hash functions.

19. The system of claim 11, wherein the one or more actions comprise at least one of:
de-identifying one or more PII in the partition; or
transmitting a notification to a generator of the first characterization.

20. A non-transitory computer-readable storage medium storing a plurality of instructions executable by one or more processors, the plurality of instructions, when executed by the one or more processors, cause the one or more processors to:
access a log data storage that stores log data, wherein the log data is structured into multiple dimensions;
isolate a partition of the log data in the log data storage, wherein the partition is associated with one dimension of the multiple dimensions and is associated with a first characterization of presence or absence of personally identifiable information (PII) in the partition;
process, using a machine-learning (ML) based classifier and based on a model, the partition to generate a second characterization of presence or absence of PII in the partition;
compare the first characterization against the second characterization; and
based on a result of the comparison, perform one or more actions.
